(19) United States
(12) Patent Application Publication
(10) Pub. No.: US 2003/0092384 A1
(43) Pub. Date: May 15, 2003

(54) Piconetwork radiotelephone interfaces for vehicles including wireless pointing and display devices

(76) Inventor: W. Anthony Ross III, Plano, TX (US)

Correspondence Address: MYERS BIGEL SIBLEY & SAJOVEC, PO BOX 37428, RALEIGH, NC, 27627, US

(21) Appl. No.: 09/993,129

(22) Filed: Nov. 14, 2001

(51) Int. Cl. H04B 5/00

(52) U.S. Cl. 455/41; 455/422

(57) ABSTRACT

A radiotelephone interface for a vehicle includes a pointing device that is configured to couple to the vehicle steering mechanism. A first wireless network interface is responsive to a radiotelephone being proximate thereto, to set up a first wireless piconetwork connection with the radiotelephone, and that is configured to wirelessly relay user pointing commands to the radiotelephone that is proximate thereto via the first wireless piconetwork connection. A display device is configured to couple to the windshield. A second wireless network interface is responsive to the radiotelephone being proximate thereto, to set up a second wireless piconetwork connection with the radiotelephone, and that is configured to wirelessly receive radiotelephone displays from the radiotelephone that is proximate thereto via the second wireless piconetwork connection, and to display the radiotelephone displays on the display device. The first and second wireless network interfaces may be first and second Bluetooth wireless network interfaces, and the radiotelephone itself may include a third Bluetooth wireless network interface.

### BACKGROUND OF THE INVENTION

This invention relates to communications systems and methods, and more particularly to radiotelephone communications systems and methods.

Radiotelephone communications systems and methods are widely used for fixed and mobile wireless communications. As used herein, the term “radiotelephone” includes cellular and satellite radiotelephones with or without a multi-line display; Personal Communications System (PCS) terminals that may combine a cellular radiotelephone with data processing, facsimile and/or data communications capabilities; Personal Digital Assistants (PDA) that can include a radio frequency transceiver and a pager, Internet/intranet access, Web browser, organizer, calendar and/or a global positioning system (GPS) receiver; and/or conventional laptop and/or palmtop receivers or other appliances, which include a radio frequency transceiver.

### SUMMARY OF THE INVENTION

Embodiments of the present invention provide a radiotelephone interface for a vehicle that includes a steering mechanism and a windshield. Embodiments of the radiotelephone interface can include a pointing device that is configured to couple to the steering mechanism. A first wireless network interface is responsive to a radiotelephone being proximate thereto, to set up a first wireless piconetwork connection with the radiotelephone, and that is configured to wirelessly relay user pointing commands to the radiotelephone that is proximate thereto via the first wireless piconetwork connection. Embodiments of the radiotelephone interface also can include a display device that is configured to couple to the windshield. A second wireless network interface is responsive to the radiotelephone being proximate thereto, to set up a second wireless piconetwork connection with the radiotelephone, and that is configured to wirelessly receive radiotelephone displays from the radiotelephone that is proximate thereto via the second wireless piconetwork connection, and to display the radiotelephone displays on the display device. The first and second wireless network interfaces may comprise first and second Bluetooth wireless network interfaces, respectively, and the radiotelephone itself may include a third Bluetooth wireless network interface. Radiotelephone interfaces according to embodiments of the present invention may be used to wirelessly relay user inputs from the pointing device that is coupled to the steering mechanism to the radiotelephone, and to wirelessly relay user displays from the radiotelephone to the display device that is coupled to the windshield.

### BRIEF DESCRIPTION OF THE DRAWINGS

FIG. 1 is a block diagram of radiotelephone interfaces for vehicles according to embodiments of the present invention.

FIG. 2 is a flowchart illustrating radiotelephone communications according to embodiments of the present invention.

FIGS. 3A-3C illustrate an example of radiotelephone communications in four- or more-wheeled vehicles according to embodiments of the invention.

FIGS. 4A-4C illustrate an example of radiotelephone communications in two-wheeled vehicles according to embodiments of the invention.

### DETAILED DESCRIPTION OF THE INVENTION

The present invention now will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout. It will be understood that when an element such as a layer, region or substrate is referred to as being “on” another element, it can be directly on the other element or intervening elements may also be present. In contrast, when an element is referred to as being “directly on” another element, there are no intervening elements present. It will also be understood that when an element is referred to as being “connected” or “coupled” to another element, it can be directly connected or coupled to the other element or intervening elements may be present. In contrast, when an element is referred to as being “directly coupled” to another element, there are no intervening elements present.

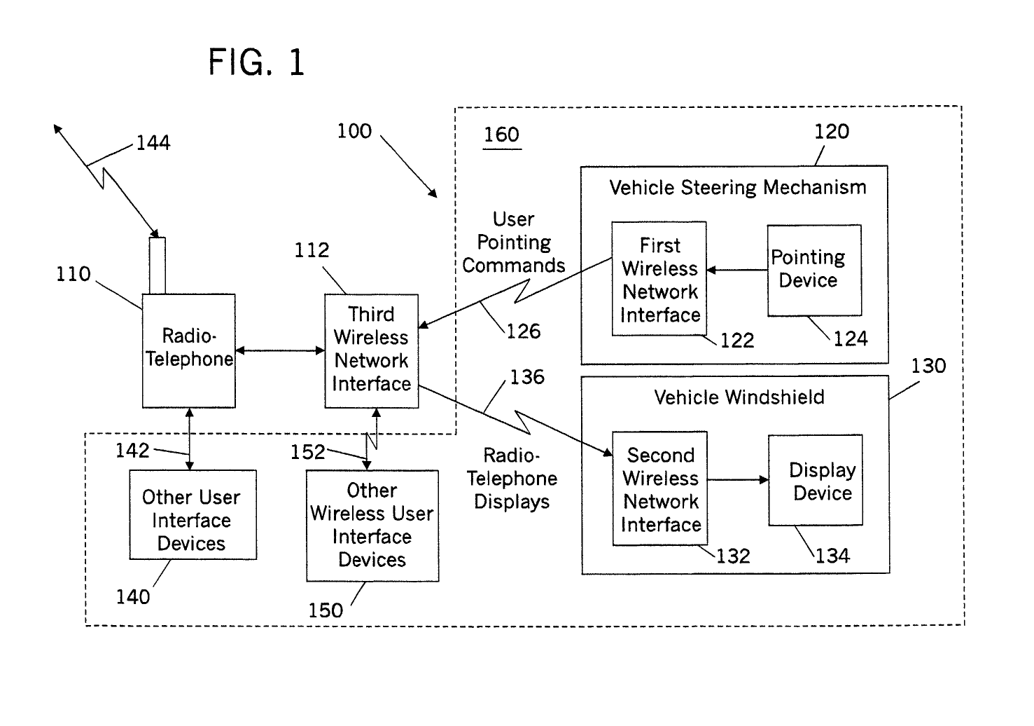

FIG. 1 is a block diagram of radiotelephone interfaces for vehicles according to embodiments of the present invention. Referring now to FIG. 1, the radiotelephone interface 100 may be used with a vehicle 160 that includes a vehicle steering mechanism 120, and a vehicle windshield 130. Embodiments of the invention can be used to provide a radiotelephone interface for a radiotelephone 110 that wirelessly communicates with other wireless radiotelephones, wired telephones, computer devices and/or other devices, at least in part, via a wireless radiotelephone network, such as a cellular radiotelephone network and/or a satellite radiotelephone network.

Still referring to FIG. 1, radiotelephone interfaces 100 according to embodiments of the invention include a pointing device 124, such as a tactile mouse, that is configured to couple to the steering mechanism 120. Thus, for example, when the vehicle is a four- or more-wheeled vehicle, the pointing device may be configured to couple to the vehicle steering wheel. Examples of pointing devices that are coupled to a vehicle steering mechanism, are described in U.S. Pat. No. 6,240,347 to Everhart et al., entitled Vehicle Accessory Control With Integrated Voice and Manual Activation, and in U.S. Pat. No. 6,226,570 to Hahn, entitled Motor Vehicle With an Automatic Vehicle Driving and Electronic Communication Devices, the disclosures of both of which are hereby incorporated herein by reference in their entirety as if set forth fully herein. The design of pointing devices that are coupled to a vehicle steering mechanism are well known to those having skill in the art, and need not be described further herein.

Still referring to FIG. 1, a first wireless network interface 122 is responsive to the radiotelephone 110 being proximate thereto to set up a first wireless piconetwork connection 126 with the radiotelephone. The first wireless network interface 122 is configured to wirelessly relay user pointing commands from the pointing device 124 to the radiotelephone 110 that is proximate thereto via the first wireless piconetwork connection 126. In some embodiments, the first wireless network interface 122 is a Bluetooth interface. As is well known to those having skill in the art, Bluetooth is a global standard that can eliminate wires and cables between both stationary and mobile devices, can facilitate both data and voice communication, and can provide ad hoc networks that can be set up automatically and provide synchronicity between network devices. Bluetooth is described in detail at www.bluetooth.com, and is described generally in a publication by Haartsen, entitled Bluetooth—The Universal Radio Interface for Ad Hoc, Wireless Connectivity, Ericsson Review No. 3, 1998, pp. 110-117, the disclosures of both of which are hereby incorporated herein by reference in their entirety as if set forth fully herein. A mobile device that includes a Bluetooth interface also is described in U.S. Pat. No. 6,255,800 to Bork, entitled Bluetooth Enabled Mobile Device Charging Cradle and System, the disclosure of which is hereby incorporated herein by reference in its entirety as if set forth fully herein. The design of short distance wireless networks (piconetworks) such as Bluetooth piconetworks are well known to those having skill in the art and need not be described further herein.

It also will be understood that the first wireless network interface 122 may be contained in a common housing with a pointing device 124 on the vehicle steering mechanism 120, or may be linked to the pointing device 124 via a cable and mounted on or off the vehicle steering mechanism 120.

Still referring to FIG. 1, a display device 134 is configured to couple to the vehicle windshield 130. A second wireless network interface 132 is responsive to the radiotelephone 110 being proximate thereto, to set up a second wireless piconetwork connection 136, such as a second Bluetooth network connection, with the radiotelephone 110. The second wireless network interface 132 is configured to wirelessly receive radiotelephone displays from the radiotelephone that is proximate thereto, via the second wireless piconetwork connection 136, and to display the radiotelephone displays on the display device 134. In some embodiments, the display device is a heads-up display that is configured to provide a display on the vehicle windshield. Heads-up displays also are described in the above-cited Everhart et al. and Hahn patents, and need not be described further herein. Moreover, the second wireless network interface 132 may be included in a common housing with the display device 134 and/or may be mounted separate from the display device 134 on or off the vehicle windshield 130. Finally, it will be understood that the first and second wireless network interfaces 122, 132, respectively, may be included in a common housing that combines the functionality of the first and second wireless piconetwork connections 126, 127, respectively.

Still referring to FIG. 1, the radiotelephone 110 also includes a third wireless network interface 112 associated therewith. The third wireless network interface 112 communicates with the first and second wireless network interfaces 122, 132, respectively, via the first and second wireless piconetwork connections 126, 127, respectively.

In some embodiments, the third wireless network interface 112 is a third Bluetooth interface. The third wireless network interface 112 may be combined in a common housing with radiotelephone 110 to provide a wireless communication device. In other embodiments, the third wireless network interface 112 may be contained in a separate housing that is permanently or semipermanently mechanically coupled to the radiotelephone 110 to provide a wireless communication device. For example, the third wireless network interface may be configured to clip onto the radiotelephone 110. In yet another example, the third wireless network interface 112 may be contained within a cradle that is mounted within the vehicle 160, which temporarily or permanently receives the radiotelephone 110 in the vehicle 160.

Finally, still referring to FIG. 1, other user interface devices 140 may communicate with the radiotelephone 110 using wired connections 142. Still other wireless user interface devices 150 may communicate with third wireless network interface 112 using other piconetwork and/or Bluetooth connections 152. The other user interface devices 140 and/or 150 can include a microphone, speaker, earpiece, printer and/or other user interface devices. It also will be understood by those having skill in the art that the first wireless network interface 122 and the second wireless network interface 132 can be combined into a single wireless network interface that is connected to both the pointing device 124 and the display device 134, as well as to the other wireless user interface devices 150.

As is well known to those having skill in the art, radiotelephones are often used for mobile communications in a vehicle, including a two-wheeled vehicle such as a motorcycle, and a four- or more-wheeled vehicle, such as an automobile or truck. When using a radiotelephone in a vehicle, it may be desirable to reduce or minimize distraction to the radiotelephone user while driving the vehicle. Thus, for example, it is known to provide speakerphones in vehicles for hands-free wireless communications. Other communications systems that can enhance safety are described in Swedish Application No. SE663A0, filed Feb. 29, 2000, to Johan Ullman entitled A Communication System for Vehicle, a Dialling Control Board, Use of a Dialling Control Board and Method for Providing a Communication System for a Vehicle, the disclosure of which is hereby incorporated herein in its entirety as if set forth fully herein. However, safety while operating a radiotelephone in a vehicle continues to be a concern.

Embodiments of the invention, for example as illustrated in FIG. 1, can allow a vehicle operator to view a radiotelephone display and provide user pointer commands while maintaining the user's eyes on the vehicle windshield 130 and the user's hands on the vehicle steering mechanism 120. Vehicle safety thereby can be enhanced.

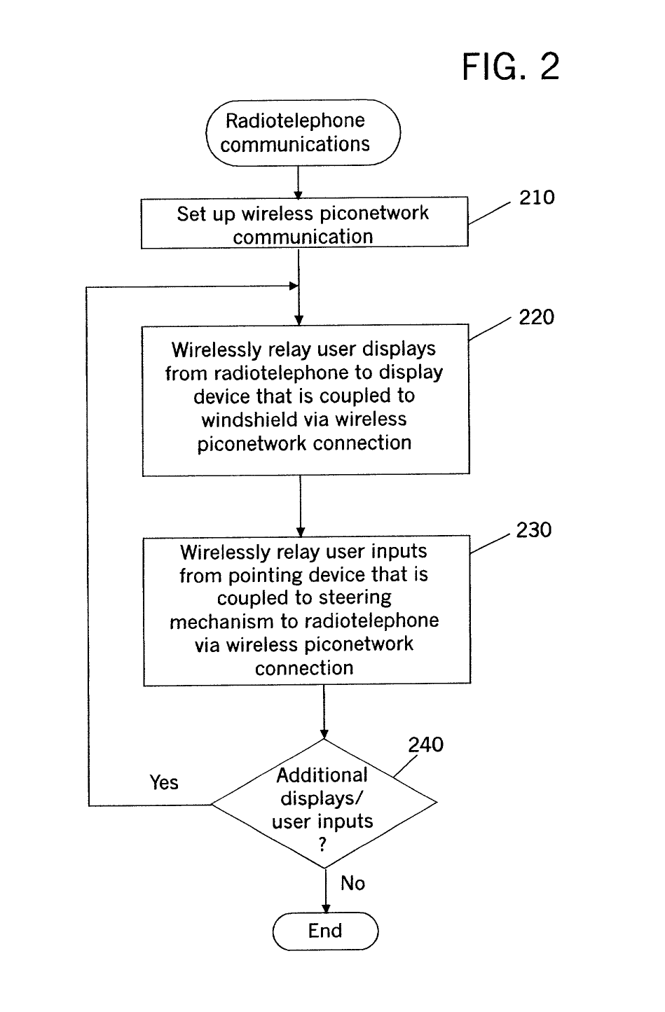

FIG. 2 is a flowchart illustrating radiotelephone communications according to embodiments of the present invention. As shown in FIG. 2 at Block 210, a wireless piconetwork connection is set up between a pointing device, such as the pointing device 124 of FIG. 1, that is coupled to a steering mechanism, such as the steering mechanism 120 of FIG. 1, a display device, such as the display device 134 of FIG. 1, that is coupled to a windshield, such as the windshield 130 of FIG. 1, and a radiotelephone, such as the radiotelephone 110 of FIG. 1, in response to the radiotelephone being proximate to the pointing device and the display device. As shown at Block 220, user displays are wirelessly relayed from the radiotelephone to the display device that is coupled to the windshield, via a wireless piconetwork connection. At Block 230, user inputs are wirelessly relayed from a pointing device that is coupled to a steering mechanism to a radiotelephone that is proximate thereto, via a wireless piconetwork connection. At Block 240, if additional displays or user inputs are desired, then operations at Block 220 and/or 230 are repeated.

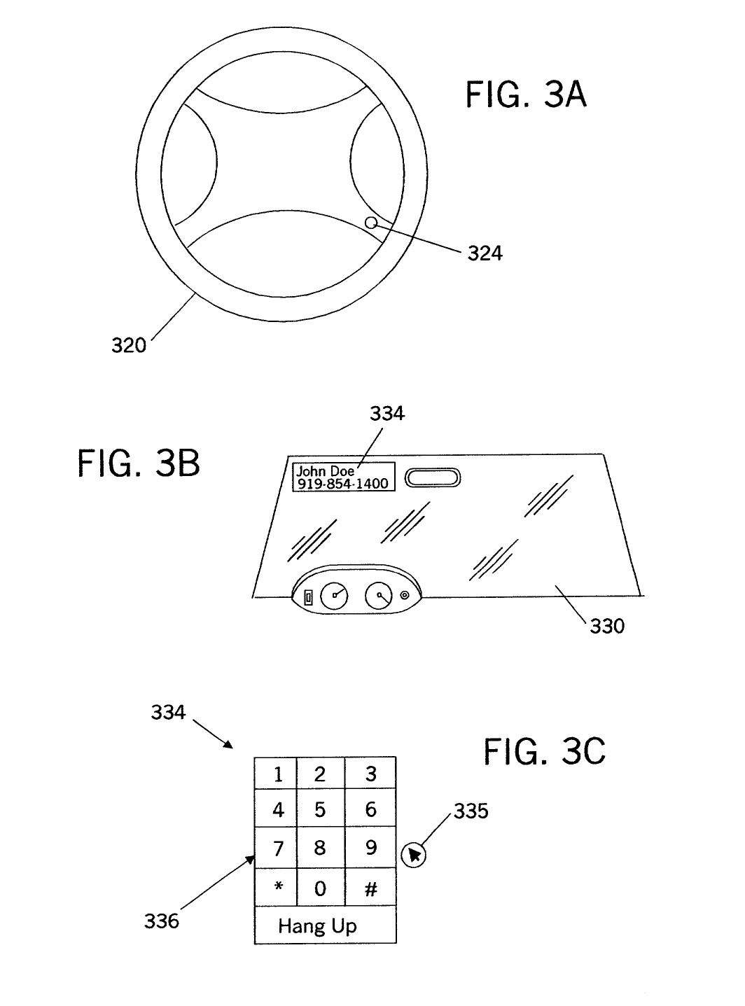

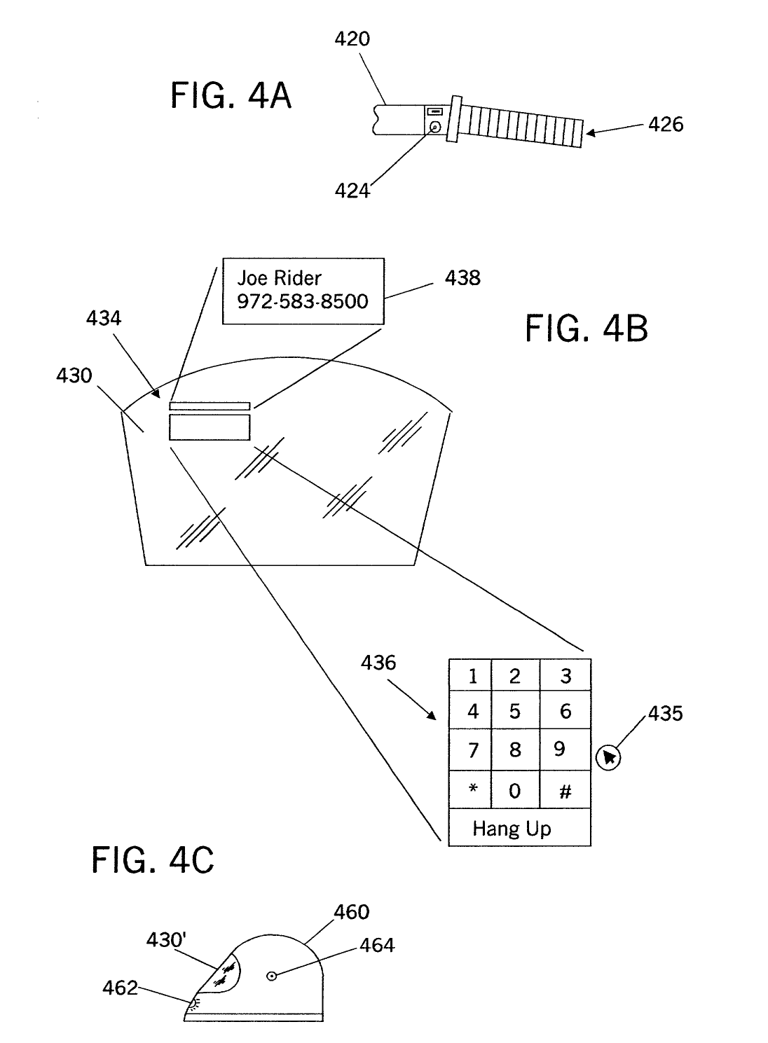

Radiotelephone interfaces and radiotelephone communication methods according to embodiments of the present invention may be used in two-wheeled vehicles, such as motorcycles, three-wheeled vehicles and/or four- or more-wheeled vehicles, such as automobiles and trucks, and also may be used for radiotelephone communication applications such as caller identification and user dialing. These applications now will be described in connection with FIGS. 3A-4C, and may be provided using embodiments of FIGS. 1 and/or 2.

Referring now to FIGS. 3A-3C, radiotelephone interfaces and communications methods according to embodiments of the invention may be used in a four- or more-wheeled vehicle for caller identification and/or dialing. These embodiments can provide, for example, a Bluetooth incoming call reception device and application, and/or a Bluetooth dialer display device and application.

Thus, an incoming radiotelephone call can be answered and/or an outgoing radiotelephone call can be initiated (dialed) without requiring the user to remove the user's hands from the steering wheel and also allowing the user to maintain eyes on the road. As was described above, the user's Bluetooth-equipped radiotelephone, such as radiotelephone 110 of FIG. 1, can sync up with the vehicle's Bluetooth vehicle safety incoming call reception device and/or dialer device at any time when the user activates or moves the radiotelephone 110 within range of the vehicle 160. Thus, a piconetwork is established to allow the devices to communicate.

Referring now to FIG. 3A, a pointing device such as a tactile mouse button 324, which may be similar to the built-in mouse interface that can be found on laptop computers and which may be an example of a pointing device 124 of FIG. 1, is mounted in or on a vehicle steering wheel 320. The mouse button 324 can be controlled by the driver's thumb, while the driver's hands still grip the steering wheel 320. Referring now to FIG. 31B, the vehicle windshield 330 includes a small translucent heads-up display grid 334 which can be built into the windshield and/or projected onto the windshield and which may be an example of a display device 134 of FIG. 1. As shown in FIG. 3B, the heads-up display 334 may be used to display the name and/or number, referred to as a “caller ID”, of an incoming call, for example using embodiments of FIG. 1.

Upon receiving an incoming call (radiotelephone communication), the caller's name and/or number are displayed on the heads-up display 334, as shown in FIG. 3B. Activation of the tactile mouse 324 of FIG. 3A, for example to the right, can answer the incoming call. Otherwise, the caller may be directed to voicemail. Once the call is completed, the driver (user) can terminate the call by moving the mouse 324, for example to the left. In some embodiments, the caller's name and number on the heads-up display 334 can disappear after a predetermined time, such as ten seconds, or after the call is answered. Accordingly, enhanced user convenience and/or user safety may be provided when answering a telephone call.

Referring now to FIG. 3C, in other embodiments, the heads-up display 334 can provide a display of a keypad 336 and/or a mouse pointer 335, to provide the driver with the ability to dial any number manually or to dial a number in the radiotelephone's phone directory or caller ID list, and thereby initiate radiotelephone communications. The mouse 324 of FIG. 3A may be used to control the mode and operations of dialing the radiotelephone. For example, moving the mouse 324 to the right can activate the heads-up display 334, which can display in the directory/caller ID mode of FIG. 3B. Moving the mouse 324, for example to the left, can activate the heads-up display 334 to display in manual dialing mode of FIG. 3C, where a keypad 336 is displayed on the windshield's heads-up display. In either mode of FIG. 3B or 3C, the heads-up display can disappear after ten seconds of mouse inactivity.

Referring again to FIG. 3B, in directory/caller ID mode, the mouse button 324 of FIG. 3A may be pressed up or down to allow the user to scroll through the phone directory and/or list of names and numbers within the radiotelephone. In order to activate the dialing of a name or number that currently is being displayed, the mouse 324 may be pressed in.

Referring again to FIG. 3C, in manual dialing mode, the keypad 336 can be displayed by the heads-up display 334 with a mouse pointer 335, to allow selection of digits to dial a desired number or to terminate the communication (hang up). The desired digit or action may be selected by pressing the mouse 324. Once the number is completed, the radiotelephone can dial that number. The hang-up button may be selected to terminate a phone call. Accordingly, enhanced safety and/or operational convenience may be provided.

FIGS. 4A-4C illustrate other embodiments of the invention that can provide incoming call reception and/or dialing systems and methods for two-wheeled vehicles such as motorcycles, for example using embodiments of FIGS. 1 and 2. It will be understood that user convenience and safety may be of particular concern for motorcycles.

Referring now to FIG. 4A, a pointing device, such as a tactile mouse 424, is incorporated within the motorcycle steering mechanism, such as the right-hand handlebar 420, adjacent the throttle 426 and which may be an example of a pointing device 124 of FIG. 1. Thus, the user can activate the mouse 424 while continuing to operate the throttle 426 and steering via the handlebars 420. The tactile mouse may be controlled by the driver's thumb. A handlebar-mounted mouse is described, for example, in U.S. Pat. No. 6,157,890 to Nakai et al., entitled Motorcycle Navigation System, the disclosure of which is hereby incorporated herein by reference in its entirety as if set forth fully herein, and need not be described further herein.

Referring now to FIG. 4B, the motorcycle windshield 430 can contain a small display, such as a heads-up display 434, which may be an example of a display device 134 of FIG. 1. The heads-up display 434 can be used to display the name and number (caller ID) 438 of an incoming call. As shown in FIG. 4C, the motorcycle helmet 460 can be equipped with a wireless headset device including a wireless microphone 462 and/or a wireless earpiece 464, that can be used to communicate once the call has been established. It also will be understood that the display 434 of FIG. 4B also may be displayed on the windshield 430′ of the motorcycle helmet 460. When an incoming call is received, the user can move the tactile mouse 424, for example to the right, if the driver wishes to answer the call. To terminate the call, the tactile mouse 424 may be moved, for example, to the left. The caller ID information 438 can remain visible for a predetermined time, such as ten seconds, or until the call is answered.

Still referring to FIGS. 4A-4C, in a dialing application, the driver can dial any number in the mobile radiotelephone's phone directory or caller ID list, or can dial a number manually. In this mode, a caller ID or phone list may be displayed, as shown at 438 and/or a keypad 436 may be displayed, as illustrated in FIG. 4B. User operations may be performed similar to those described in FIGS. 3A-3C. Once the call is established, the microphone 462 and/or earpiece 464 may be used for communications.

In the drawings and specification, there have been disclosed typical preferred embodiments of the invention and, although specific terms are employed, they are used in a generic and descriptive sense only and not for purposes of limitation, the scope of the invention being set forth in the following claims.

1. A radiotelephone interface for a vehicle that includes a steering mechanism and a windshield, the radiotelephone interface comprising:
a pointing device that is configured to couple to the steering mechanism;
a first wireless network interface that is responsive to a radiotelephone being proximate thereto to set up a first wireless piconetwork connection with the radiotelephone, and that is configured to wirelessly relay user pointing commands from the pointing device to the radiotelephone that is proximate thereto via the first wireless piconetwork connection;
a display device that is configured to couple to the windshield; and
a second wireless network interface that is responsive to the radiotelephone being proximate thereto to set up a second wireless piconetwork connection with the radiotelephone, and that is configured to wirelessly receive radiotelephone displays from the radiotelephone that is proximate thereto via the second wireless piconetwork connection and to display the radiotelephone displays on the display device.

2. The radiotelephone interface according to claim 1 wherein the first and second wireless network interfaces comprise first and second Bluetooth wireless network interfaces, respectively.

3. The radiotelephone interface according to claim 1 wherein the pointing device comprises a tactile mouse that is configured to mount on the steering mechanism.

4. The radiotelephone interface according to claim 1 wherein the display device comprises a heads-up display that is configured to display on the windshield.

5. The radiotelephone interface according to claim 3 wherein the display device comprises a heads-up display that is configured to display on the windshield.

6. The radiotelephone interface according to claim 5 wherein the vehicle is a four-or more wheeled vehicle, wherein the steering mechanism comprises a steering wheel and wherein the tactile mouse is configured to mount on the steering wheel.

7. The radiotelephone interface according to claim 5 wherein the vehicle is a motorcycle, wherein the steering mechanism comprises a handlebar and wherein the tactile mouse is configured to mount on the handlebar.

8. The radiotelephone interface according to claim 7 wherein the motorcycle further comprises a motorcycle helmet and wherein the windshield is coupled to the motorcycle helmet.

9. The radiotelephone interface according to claim 2 wherein the radiotelephone comprises a third Bluetooth wireless network interface.

10. The radiotelephone interface according to claim 2 further comprising a cradle that is configured to couple the radiotelephone to the vehicle, wherein the cradle comprises a third Bluetooth wireless network interface.

11. The radiotelephone interface according to claim 1 wherein the radiotelephone is configured to generate a caller identification in response to receipt of a radiotelephone call from a caller, wherein the second wireless network interface is further configured to wirelessly receive the caller identification, wherein the display device is further configured to display the caller identification, and wherein the pointing device is configured to accept a user input to accept the radiotelephone call and to wirelessly relay the user input to the radiotelephone via the first wireless network interface.

12. The radiotelephone interface according to claim 1 wherein the radiotelephone is configured to generate a keypad display, wherein the second wireless network interface is further configured to wirelessly receive the keypad display, wherein the display device is further configured to display the keypad display, and wherein the pointing device is configured to accept a user input of a key on the keypad display and to wirelessly relay the user input of a key to the radiotelephone via the first wireless network interface.

13. The radiotelephone interface according to claim 1 in combination with a vehicle, wherein the pointing device is coupled to the steering mechanism and the display device is coupled to the windshield.

14. A radiotelephone interface for a vehicle comprising:
a pointing device that is configured to mount in the vehicle;
a first wireless network interface that is responsive to a radiotelephone being proximate thereto to set up a first wireless piconetwork connection with the radiotelephone, and that is configured to wirelessly relay user pointing commands from the pointing device to the radiotelephone that is proximate thereto via the first wireless piconetwork connection;
a display device that is configured to mount in the vehicle; and
a second wireless network interface that is responsive to the radiotelephone being proximate thereto to set up a second wireless piconetwork connection with the radiotelephone and that is configured to wirelessly receive radiotelephone displays from the radiotelephone that is proximate thereto via the second wireless piconetwork connection and to display the radiotelephone displays on the display device.

15. The radiotelephone interface according to claim 14 wherein the first and second wireless network interfaces comprise first and second Bluetooth wireless network interfaces, respectively.

16. The radiotelephone interface according to claim 14 wherein the pointing device comprises a tactile mouse that is configured to mount in the vehicle.

17. The radiotelephone interface according to claim 14 wherein the display device comprises a heads-up display that is configured to display in the vehicle.

18. The radiotelephone interface according to claim 15 wherein the radiotelephone comprises a third Bluetooth wireless network interface.

19. The radiotelephone interface according to claim 15 further comprising a cradle that is configured to couple the radiotelephone to the vehicle, wherein the cradle comprises a third Bluetooth wireless network interface.

20. The radiotelephone interface according to claim 14 wherein the radiotelephone is configured to generate a caller identification in response to receipt of a radiotelephone call from a caller, wherein the second wireless network interface is further configured to wirelessly receive the caller identification, wherein the display device is further configured to display the caller identification, and wherein the pointing device is configured to accept a user input to accept the radiotelephone call and to wirelessly relay the user input to the radiotelephone via the first wireless network interface.

21. The radiotelephone interface according to claim 14 wherein the radiotelephone is configured to generate a keypad display, wherein the second wireless network interface is further configured to wirelessly receive the keypad display, wherein the display device is further configured to display the keypad display, and wherein the pointing device is configured to accept a user input of a key on the keypad display and to wirelessly relay the user input of a key to the radiotelephone via the first wireless network interface.

22. The radiotelephone interface according to claim 14 in combination with a vehicle, wherein the pointing device and the display device are mounted in the vehicle.

23. A radiotelephone interface for a motorcycle that includes a motorcycle helmet, the radiotelephone interface comprising:
a radiotelephone user interface that is configured to mount on the motorcycle helmet; and
a wireless piconetwork interface that is configured to mount on the motorcycle helmet and that is responsive to a radiotelephone being proximate thereto to set up a wireless piconetwork connection with the radiotelephone and to wirelessly relay user inputs and outputs between the motorcycle helmet and the radiotelephone that is proximate thereto via the wireless piconetwork connection.

24. The radiotelephone interface according to claim 23 wherein the radiotelephone user interface comprises at least one of a loudspeaker, a microphone, a display and a pointing device.

25. The radiotelephone interface according to claim 23 wherein the wireless piconetwork interface comprises a Bluetooth wireless network interface.

26. The radiotelephone interface according to claim 23 wherein the user interface comprises a loudspeaker, a microphone and a display that are configured to mount in the motorcycle helmet and a pointing device that is configured to mount on the motorcycle handlebars.

27. The radiotelephone interface according to claim 23 wherein the radiotelephone comprises a wireless piconetwork interface.

28. The radiotelephone interface according to claim 23 in combination with a motorcycle helmet, wherein the radiotelephone user interface and the wireless piconetwork interface are mounted on the helmet.

29. A radiotelephone communication method for a user in a vehicle that includes a steering mechanism and a windshield, the radiotelephone communication method comprising:
setting up a wireless piconetwork connection between a pointing device that is coupled to the steering mechanism, a display device that is coupled to the windshield and a radiotelephone, in response to the radiotelephone being proximate to the pointing device and the display device;
wirelessly relaying user inputs from the pointing device that is coupled to the steering mechanism to the radiotelephone that is proximate thereto via the wireless piconetwork connection; and
wirelessly relaying user displays from the radiotelephone to the display device that is coupled to the windshield via the wireless piconetwork connection.

30. The method according to claim 29 wherein the wireless piconetwork connection comprises a Bluetooth wireless network connection.

31. The method according to claim 29:
wherein the wirelessly relaying user displays from the radiotelephone to the display device that is coupled to the windshield via the wireless piconetwork connection comprises wirelessly relaying a caller identification from the radiotelephone to the display device that is coupled to the windshield via the wireless piconetwork connection in response to receipt of a radiotelephone call from a caller; and
wherein the wirelessly relaying user inputs from the pointing device that is coupled to the steering mechanism to the radiotelephone that is proximate thereto via the wireless piconetwork connection comprises wirelessly relaying a user input to accept the radiotelephone call from the pointing device that is coupled to the steering mechanism to the radiotelephone that is proximate thereto via the wireless piconetwork connection.

32. The method according to claim 29:
wherein the wirelessly relaying user displays from the radiotelephone to the display device that is coupled to the windshield via the wireless piconetwork connection comprises wirelessly relaying a keypad display from the radiotelephone to the display device that is coupled to the windshield via the wireless piconetwork connection; and
wherein the wirelessly relaying user inputs from the pointing device that is coupled to the steering mechanism to the radiotelephone that is proximate thereto via the wireless piconetwork connection comprises wirelessly relaying a user input of a key on the keypad display from the pointing device that is coupled to the steering mechanism to the radiotelephone that is proximate thereto via the wireless piconetwork connection.

33. A wireless communication device comprising:
a radiotelephone that is configured to communicate with a cellular and/or satellite radiotelephone network; and
a wireless piconetwork interface that is responsive to the radiotelephone being proximate to a vehicle to set up a wireless piconetwork connection with the vehicle, that is configured to wirelessly receive user pointing commands from the vehicle via the wireless piconetwork connection and that is configured to wirelessly relay radiotelephone displays from the radiotelephone to the vehicle via the wireless piconetwork connection.

34. The wireless communication device according to claim 33 wherein the wireless piconetwork interface comprises a Bluetooth wireless network interface.

35. The wireless communication device according to claim 33 wherein the radiotelephone is configured to generate a caller identification in response to receipt of a radiotelephone call from a caller, wherein the wireless piconetwork interface is further configured to wirelessly relay the caller identification to the vehicle via the wireless piconetwork connection, and wherein the wireless piconetwork interface is further configured to relay a user input to accept the radiotelephone call that is received from the wireless piconetwork connection to the radiotelephone.

36. The wireless communication device according to claim 33 wherein the radiotelephone is configured to generate a keypad display, wherein the wireless piconetwork interface is further configured to wirelessly relay the keypad display to the vehicle via the wireless piconetwork connection, and wherein the wireless piconetwork interface is further configured to accept a user input of a key on the keypad display from the wireless piconetwork connection and to relay the user input of a key to the radiotelephone.
